(19) United States
(12) Patent Application Publication
(10) Pub. No.: US 2026/0146792 A1
(43) Pub. Date: May 28, 2026

(54) METHOD FOR INTELLIGENTLY CONTROLLING FREEZE DRYER, AND FREEZE-DRYING SYSTEM

(71) Applicant: Ascend Intelligent (shanghai)Technology Co., Ltd., Shanghai (CN)

(72) Inventors: Jie CHEN, Shanghai (CN); Xiaye FANG, Shanghai (CN)

(21) Appl. No.: 19/453,016

(22) Filed: Jan. 20, 2026

(30) Foreign Application Priority Data
Nov. 10, 2025 (CN) 202511635682.8

(51) Int. Cl. F26B 5/06

(52) U.S. Cl. CPC F26B 5/06

(57) ABSTRACT

A method for intelligently controlling a freeze dryer, in which initialization parameters of the freeze dryer, including a temperature sett value and a vacuum degree set value, are obtained, and a temperature feedback value and a vacuum degree feedback value are collected; whether the vacuum degree feedback value meets a preset condition is determined; if yes, a temperature command value is calculated through a proportional-integral (PI) algorithm according to the vacuum degree feedback value and the vacuum degree set value; otherwise, the temperature command value is set to the temperature set value; a temperature error is calculated according to the temperature command value and the temperature feedback value, and a pulse-width modulation (PWM) duty cycle is calculated through a proportional-integral-derivative (PID) algorithm based on the temperature error.

### CROSS-REFERENCE TO RELATED APPLICATIONS

This application claims the benefit of priority from Chinese Patent Application No. 202511635682.8, filed on Nov. 10, 2025. The content of the aforementioned application, including any intervening amendments thereto, is incorporated herein by reference in its entirety.

### TECHNICAL FIELD

This application relates to freeze dryer control technologies, and more particularly to a method for intelligently controlling a freeze dryer, and a freeze-drying system.

### BACKGROUND

Freeze dryer is designed to removes moisture from materials through direct sublimation under low-temperature and vacuum conditions, and has been widely used in the fields of pharmaceuticals, biological products and food. The key to a freeze-drying process lies in the effective control of temperature and vacuum degree. Temperature control offers an appropriate heating condition to trigger the sublimation, while vacuum degree control maintains a low-pressure environment to facilitate rapid evaporation and removal of the moisture. Excellent freeze-drying effects can be realized only through reasonable adjustment of both the temperature and vacuum conditions. In the existing control strategies of the freeze dryer, a certain temperature range is maintained through start/stop control of heating elements while keeping a preset vacuum range through an on-off full-power control of a vacuum pump. Such control has a simple structure, and can meet basic requirements of the freeze-drying process, but it still struggles with some limitations.

Specifically, such control method will cause frequent start and stop of the heating elements and the vacuum pump, resulting in high energy consumption and failing to achieve the energy conservation. Meanwhile, the existing control methods fail to achieve the precise adjustment of the temperature and vacuum degree, and thus do not conform to the requirements of the modern freeze-drying process in terms of precision and stability.

### SUMMARY

In view of the above defects, this application provides a method for intelligently controlling a freeze dryer, and a freeze-drying system, so as to solve the problems of high energy consumption and limited temperature control accuracy in the existing freeze dryers.

In order to solve the above problems, this application provides technical solution as follows.

In a first aspect, this application provides a method for intelligently controlling a freeze dryer, comprising:
obtaining initialization parameters of the freeze dryer, and collecting a temperature feedback value and a vacuum degree feedback value of the freeze dryer; wherein the initialization parameters comprise a temperature set value and a vacuum degree set value;
determining whether the vacuum degree feedback value meets a preset condition; if yes, calculating a temperature command value through a proportional-integral (PI) algorithm according to the vacuum degree feedback value and the vacuum degree set value, otherwise, setting the temperature command value to the temperature set value;
calculating a temperature error according to the temperature command value and the temperature feedback value; and calculating a pulse-width modulation (PWM) duty cycle through a proportional-integral-derivative (PID) algorithm based on the temperature error; and
generating a PWM signal based on the PWM duty cycle, and transmitting the PWM signal to a power drive circuit of the freeze dryer, such that the power drive circuit adjusts an actual power output of a heater of the freeze dryer according to the PWM signal to achieve temperature control.

In an embodiment, the preset condition is that a current rotation speed of a brushless permanent magnet (BLPM) motor connected with a vacuum pump of the freeze dryer reaches a maximum rotation speed, and the vacuum degree feedback value continues to increase.

In an embodiment, step of calculating the temperature command value through the PI algorithm according to the vacuum degree feedback value and the vacuum degree set value comprises:
calculating a vacuum degree error according to Ze(t)=Zset−Zmeas(t), wherein Zmeas(t) represents the vacuum degree feedback value, Zset represents the vacuum degree set value, and Ze(t) represents the vacuum degree error; and
calculating the temperature command value according to Tcmd(t)=Tset−[Kp,vac*Ze(t)+Ki,vacΣZe(t)], wherein Tcmd(t) represents the temperature command value, Tset represents the temperature set value, Kp,vac represents a preset vacuum degree proportional gain coefficient, Ki,vac represents a preset vacuum degree integral gain coefficient, and ΣZe(t) represents a cumulative sum of the vacuum degree error from an initial moment to a current moment; and
step setting the temperature command value to the temperature set value comprises:
designating the temperature command value as Tcmd(t) and the temperature set value as Tset, wherein Tcmd(t)=Tset.

In an embodiment, step of calculating the temperature error according to the temperature command value and the temperature feedback value comprises:
calculating the temperature error according to e(t)=Tcmd(t)−Tmeas(t), wherein Tmeas(t) represents the temperature feedback value, and e(t) represents the temperature error.

In an embodiment, step of calculating the PWM duty cycle through the PID algorithm based on the temperature error comprises:
calculating an output of a PID controller according to U(t)=Kp,temp*e(t)+Ki,tempΣe(t)+Kd,temp*[e(t)−e(t−1)], wherein U(t) represents the output of the PID controller, Kp,temp represents a preset temperature proportional gain coefficient, Ki,temp represents a preset temperature integral gain coefficient, Kd,temp represents a preset temperature differential gain coefficient, e(t) represents a temperature error at the current moment, e(t−1) represents a temperature error at a previous sampling moment, and Σe(t) represents a cumulative sum of the temperature error from the initial moment to the current moment; and
converting the output of the PID controller into the PWM duty cycle through a preset linear mapping relationship.

In an embodiment, the method, after step of transmitting the PWM signal to the power drive circuit of the freeze dryer, further comprises:
obtaining the current rotation speed of the BLPM motor; and determining whether the vacuum degree error is greater than a preset threshold;
if the vacuum degree error is greater than the preset threshold, adjusting the current rotation speed of the BLPM motor to a preset initial rotation speed; and
if the vacuum degree error is not greater than the preset threshold, switching the freeze dryer to a vacuum degree PID control mode; calculating an output rotation speed through the PID algorithm based on the vacuum degree error; converting the output rotation speed into a drive signal, and outputting the drive signal to the BLPM motor, so as to drive the BLPM motor to adjust the current rotation speed to the output rotation speed to realize vacuum degree adjustment.

In an embodiment, step of calculating the output rotation speed through the PID algorithm based on the vacuum degree error comprises:
calculating the output rotation speed according to M(t)=Kp,vac*Ze(t)+Ki,vacΣZe(t)+Kd,vac*[Ze(t)−Ze(t−1)]+ZFM(t); wherein M(t) represents the output rotation speed, Kp,vac represents the preset vacuum degree proportional gain coefficient, Ki,vac represents the preset vacuum degree integral gain coefficient, Kd,vac represents a preset vacuum degree differential gain coefficient, Ze(t) represents a vacuum degree error at the current moment, Ze(t−1) represents a vacuum degree error at a previous sampling moment, ΣZe(t) represents the cumulative sum of the vacuum degree error from the initial moment to the current moment, and ZFM(t) represents a preset rotation speed feedforward value of the BLPM motor.

In an embodiment, after step of switching the freeze dryer to the vacuum degree PID control mode, and prior to step of calculating the output rotation speed through the PID algorithm based on the vacuum degree error, the method further comprises:
if it is determined to enter a first control cycle of the vacuum degree PID control mode, and initializing an error the cumulative sum for integral control in the PID algorithm by assigning an initial integral value to the error cumulative sum, wherein the initial integral value is calculated based on the vacuum degree error and preset parameters.

In an embodiment, the power drive circuit comprises a first resistor, a second resistor, a third resistor, a first capacitor, an optoelectronic isolator, a second capacitor, a fourth resistor, a first voltage-regulator diode, a second voltage-regulator diode, a fifth resistor, a third capacitor, a metal-oxide-semiconductor field-effect transistor and a diode; and
a first pin of the optoelectronic isolator is connected with a first end of the first resistor, a first end of the third resistor, and a first end of the first capacitor; a second pin of the optoelectronic isolator is connected with a first end of the second resistor, a second end of the third resistor and a second end of the first capacitor; a second end of the first resistor is connected with a 3.3V power supply terminal; a second end of the second resistor is connected with a PWM signal end; a third pin of the optoelectronic isolator is grounded; a fourth pin of the optoelectronic isolator is connected with a first end of the fourth resistor; a fifth pin of the optoelectronic isolator is connected with a 15V power supply terminal and a first end of the second capacitor; a second end of the second capacitor is grounded; a second end of the fourth resistor is connected with a negative electrode of the first voltage-regulator diode, a first end of the fifth resistor, a first end of the third capacitor and a grid electrode of the MOSFET; a positive electrode of the first voltage-regulator diode is connected with a positive electrode of the second voltage-regulator diode; a negative electrode of the second voltage-regulator diode is connected with a second end of the fifth resistor, a second end of the third capacitor, a source electrode of the MOSFET and a ground end; a drain electrode of the MOSFET is connected with a positive electrode of the diode and the heater of the freeze dryer; and a negative electrode of the diode is connected with a BUS+ terminal.

In a second aspect, this application also provides a freeze-drying system, comprising:
a freeze dryer; and
a control system;
wherein the freeze dryer is electrically connected with the control system;
the control system comprises a memory and a processor; and
the memory is configured to store a program instruction; and the processor is configured to execute the program instruction to perform the method above.

The present disclosure has the following beneficial effects. The present disclosure provides the method for intelligently controlling the freeze dryer, and the freeze-drying system. The present disclosure can continuously adjust a power of the heater by real-time collection of the temperature feedback value and the vacuum degree feedback value and dynamic calculation of the temperature command value and the PWM duty cycle, avoiding frequent on-off problems caused by traditional on-off switch control, which effectively reduces energy consumption and wear of devices. In the present disclosure, the temperature command value is adjusted based on the vacuum degree feedback value and the PI algorithm, so as to ensure the temperature control is in coordination with the vacuum state. The PWM duty cycle is calculated though the PID algorithm, where the PID algorithm can adjust the power of the heater in real time according to the temperature error and its changing trend, achieving real-time control of a heating process. Compared to conventional on-off control methods, a closed-loop control strategy of the present disclosure can not only significantly improve accuracy and stability of temperature adjustment, but also realize more energy-efficient operation, which significantly improves overall performance and reliability of the freeze dryer.

### BRIEF DESCRIPTION OF THE DRAWINGS

In order to illustrate the technical solutions of the embodiments of this application or the prior art more clearly, the accompanying drawings required in the description of the embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a flow chart of a method for intelligently controlling a freeze dryer according to Embodiment 1 of the present disclosure.

FIG. 2 is a flow chart of the method for intelligently controlling the freeze dryer according to Embodiment 2 of the present disclosure.

FIG. 3 is a flow chart of the method for intelligently controlling the freeze dryer according to Embodiment 3 of the present disclosure.

FIG. 4 is schematic diagram of a power drive circuit of the method for intelligently controlling the freeze dryer according to an embodiment of the present disclosure.

FIG. 5 is a flow chart of the method for intelligently controlling the freeze dryer according to Embodiment 4 of the present disclosure.

FIG. 6 is a flow chart of the method for intelligently controlling the freeze dryer according to Embodiment 5 of the present disclosure.

FIG. 7 is a structural diagram of a control system in a hardware operating environment according to an embodiment of the present disclosure.

The realization of the objectives, functional features and advantages of the present disclosure will be further described with reference to the embodiments and the accompanying drawings.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that the terms, such as “up”, “down”, “left”, “right”, “front”, “rear” and other directional indications used herein, are only used for illustrating relative position relationship and motion between components in a specific state (as shown in the accompanying drawings). If the specific state changes, the directional indication accordingly changes.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. Besides, the term “and/or” used herein includes three solutions, for example, “A” and/or “B” includes solution “A”, solution “B”, and a combination thereof. Technical solutions of embodiments can be combined with each other as long as the combined solution can be implemented by those skilled in the art. When a combination of the technical solutions is contradictory or cannot be realized, it should be considered that such a combination does not exist, and is not within the scope of the present disclosure.

It should be noted that pulse width modulation (PWM) is a commonly used temperature adjustment technology. Such technology performs high-frequency switching control on a heating element, and adjusts a duty cycle of a PWM signal, that is a ratio of a high-level duration to a cycle time, realizing precise control of an average power of the heating element, so as to achieve precise temperature adjustment. If the duty cycle is 100%, the heating element operates at full power. If the duty cycle is 50%, the heating element operates at half power. If the duty cycle is 0%, the heating element is turned off. The PWM technology has advantages of low power loss of switching components, high control accuracy, fast response speed, simple implementation and low cost.

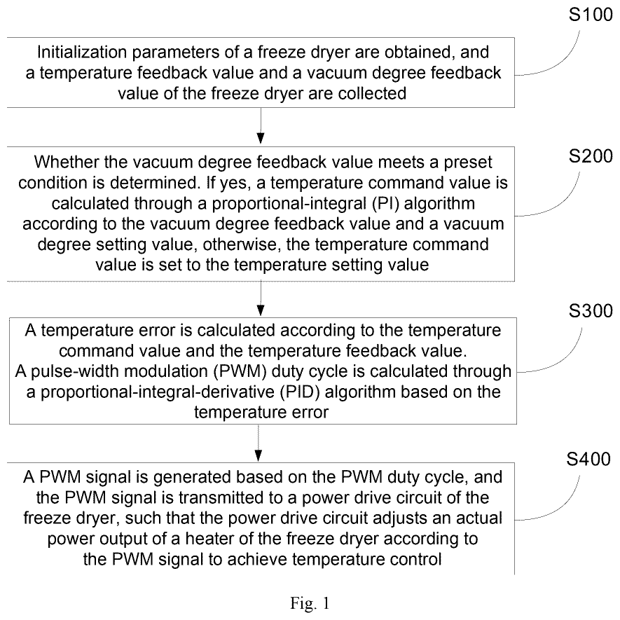

FIG. 1 is a flow chart of a method for intelligently controlling a freeze dryer according to Embodiment 1 of the present disclosure.

In this embodiment, the method includes the following steps.

(S100) Initialization parameters of the freeze dryer are obtained, and a temperature feedback value and a vacuum degree feedback value of the freeze dryer are collected.

In this step, the initialization parameters include a temperature set value and a vacuum degree set value.

In an embodiment, the initialization parameters are critical control target values preset before the freeze dryer operate an intelligent control mode, and the initialization parameters mainly include the temperature set value and the vacuum degree set value, where the temperature set value is a reference temperature that expected to be reached or maintained during a freeze-drying process, which is configured to guide a heating intensity and a temperature control strategy of a heater; and the vacuum degree set value is a reference value of a vacuum environment required during the freeze-drying process, which is configured to ensure that a material can be dried under a suitable low-pressure environment, thereby guaranteeing efficiency and quality of the freeze-drying process.

(S200) Whether the vacuum degree feedback value meets a preset condition is determined. If yes, a temperature command value is calculated through a proportional-integral (PI) algorithm according to the vacuum degree feedback value and the vacuum degree set value, otherwise, the temperature command value is set to the temperature set value.

In an embodiment, the vacuum degree feedback value is vacuum data of a cold trap of the freeze dryer measured in real time by a vacuum sensor, which reflects an actual vacuum state of a freeze-drying operating condition. The temperature feedback value is temperature data of a chamber of the freeze dryer collected in real time by a temperature sensor, which is configured to monitor temperature changes during the freeze-drying process. A proportional-integral (PI) algorithm is used to dynamically adjust the temperature command value according to a difference between the vacuum degree feedback value and the vacuum degree set value, so as to realize precise temperature control and stable response. In this embodiment, the PI algorithm is performed at intervals of 1 second, so as to timely response to changes of vacuum degrees and realize real-time coordinated control of temperature and vacuum degree.

(S300) A temperature error is calculated according to the temperature command value and the temperature feedback value. A pulse-width modulation (PWM) duty cycle is calculated through a proportional-integral-derivative (PID) algorithm based on the temperature error.

In an embodiment, the temperature error represents a difference between the temperature command value and the temperature feedback value. The PID algorithm is used to calculate the PWM duty cycle based on the temperature error and its change tendency. The PWM duty cycle determines an on-off time ratio of the heater to adjust a heating power and achieve precise temperature control. In this embodiment, the PID algorithm is performed at intervals of 0.1 second, so as to ensure real-time responsiveness and accuracy in temperature adjustment.

It should be noted that a frequency of a PWM signal is fixed and can be selected within a range of 100 Hz to 20 kHz. At present, a fixed frequency of 10 kHz is selected. A resolution of PWM pulse width can be adjusted between 0.01% and 1%. At present, an accuracy of a set pulse width is 0.1%. A PWM temperature adjustment technology can be used to significantly enhance energy-saving effect of the freeze dryer, reduce electromagnetic and mechanical noise, and improve overall operational efficiency.

(S400) The PWM signal is generated based on the PWM duty cycle, and the PWM signal is transmitted to a power drive circuit of the freeze dryer, such that the power drive circuit adjusts an actual power output of a heater of the freeze dryer according to the PWM signal to achieve temperature control.

In an embodiment, the power drive circuit performs chopping control on a rectified 110V direct current (DC) bus (BUS+110V) based on the PWM signal. The chopping control is performed through quickly switching on and off a DC current to adjust a size of an input current of the heater, thereby precisely controlling a power of the heater. A frequency of the chopping control is not affected by a alternating current period and can reach up to 20 kHz at most, effectively reducing the impact on the power supply and ensuring a more stable current for the heater.

Compared to the prior art, the method for intelligently controlling a freeze dryer of the present disclosure can continuously adjust a power of the heater by real-time collection of the temperature feedback value and the vacuum degree feedback value and dynamic calculation of the temperature command value and the PWM duty cycle, avoiding frequent on-off problems caused by traditional on-off switch control, which effectively reduces energy consumption and wear of devices. In the present disclosure, the temperature command value is adjusted based on the vacuum degree feedback value and the PI algorithm, so as to ensure the temperature control is in coordination with the vacuum state. The PWM duty cycle is calculated though the PID algorithm, where the PID algorithm can adjust the power of the heater in real time according to the temperature error and its changing trend, achieving real-time control of a heating process. Compared to conventional on-off control methods, a closed-loop control strategy of the present disclosure can not only significantly improve accuracy and stability of temperature adjustment, but also realize more energy-efficient operation, which significantly improves overall performance and reliability of the freeze dryer.

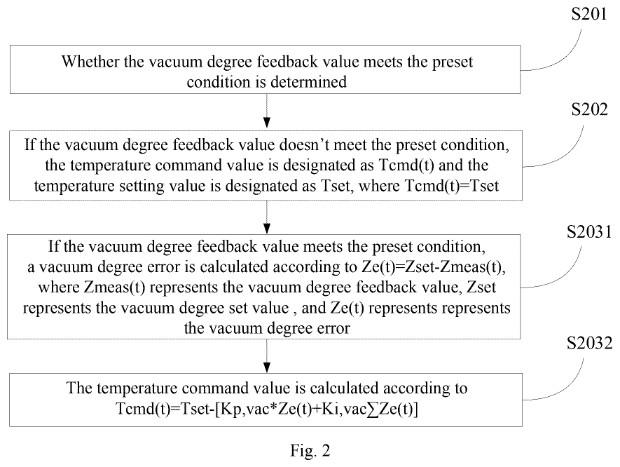

FIG. 2 is a flow chart of the method for intelligently controlling the freeze dryer according to Embodiment 2. Compared to other embodiments of the method, this embodiment provides a detailed description of the steps to obtain the temperature command value of the present disclosure.

In this embodiment, step (S200) includes the following steps.

(S201) Whether the vacuum degree feedback value meets the preset condition is determined.

In this step, the preset condition is that a current rotation speed of a brushless permanent magnet (BLPM) motor connected with a vacuum pump of the freeze dryer reaches a maximum rotation speed, and the vacuum degree feedback value continues to increase.

In an embodiment, compared to a conventional brush motor, the BLPM motor has advantages of long service life, high efficiency, low noise and less maintenance. If a current rotation speed of the vacuum pump, that is the current rotation speed of the BLPM motor, and the two values thereof are basically the same reaches the maximum rotation speed, and the vacuum degree feedback value continues to increase, that is, a pressure continues to decrease, it indicates that the vacuum pump is at its maximum pumping capacity and the vacuum environment is constantly strengthening. However, in the freeze-drying process, although a relatively high vacuum degree is required to promote drying, an excessively high vacuum degree may affect the stability of the process and the safety of the devices. Therefore, it is necessary to reasonably control the vacuum degree, avoid excessive vacuuming, and ensure the safe and stable operation of the freeze dryer. It can be seen that if the preset condition is met, the vacuum degree needs to be appropriately reduced, that is, the pressure needs to be increased, so as to ensure safe and stable operation of the freeze dryer. At this time, the PI algorithm dynamically adjusts the temperature command value based on the vacuum degree error, where an adjustment direction is to lower the temperature command value, thereby reducing the heating power, lowering material temperature and evaporation rate, and achieving purposes of appropriately reducing the vacuum degree and increasing the pressure.

(S202) The temperature command value is designated as Tcmd(t) and the temperature set value is designated as Tset, where Tcmd(t)=Tset.

In an embodiment, the preset condition doesn't be met, it indicates that the vacuum pump has not reached the maximum rotation speed, and/or the vacuum degree has not continuously increased. In this situation, the freeze dryer r is in a relatively stable state, at this time, the temperature command value will be maintained at a preset reference value, that is, the temperature set value without additional adjustment, which reduces unnecessary intervention and maintains smooth operation and normal work of the freeze-drying process.

(S2031) If the vacuum degree feedback value meets the preset condition, a vacuum degree error is calculated according to Ze(t)=Zset−Zmeas(t), where Zmeas(t) represents the vacuum degree feedback value, Zset represents the vacuum degree set value, and Ze(t) represents represents the vacuum degree error.

In an embodiment, the vacuum degree error is a difference between a target value of the vacuum degree and an actual value of the vacuum degree, that is, a difference between the vacuum degree set value and the vacuum degree feedback value. The vacuum degree error is one of key data for temperature control and adjustment of the freeze dryer.

(S2032) The temperature command value is calculated according to Tcmd(t)=Tset−[Kp,vac*Ze(t)+Ki,vacΣZe(t)], where Tcmd(t) represents the temperature command value, Tset represents the temperature set value, Kp,vac represents a preset vacuum degree proportional gain coefficient, Ki,vac represents a preset vacuum degree integral gain coefficient, and ΣZe(t) represents a cumulative sum of the vacuum degree error from an initial moment to a current moment.

In an embodiment, the temperature command value is a target temperature actually executed by the chamber of the freeze dryer. The temperature set value is the reference temperature that expected to be reached or maintained in the chamber of the freeze dryer. When the vacuum degree feedback value deviates from the temperature set value, a proportional term Kp,vac*Ze(t) immediately adjusts the temperature command value to rapidly respond to such deviation. An integral term Ki,vacΣZe(t) eliminates long-term deviation, ensuring the accuracy of the temperature command value when the freeze dryer operates in a steady state. The proportional term Kp,vac*Ze(t) and the integral term Ki,vacΣZe(t) are subtracted, so that the temperature command value is automatically adjusted according to changes of the vacuum degrees, achieving coordinated control between temperature and vacuum degree.

The method of the present disclosure introduces a vacuum degree feedback signal of the cold trap of the freeze dryer during the temperature control process to assist PID control, thereby enhancing the response speed and control accuracy of temperature control, and better meeting the requirements of the freeze-drying process.

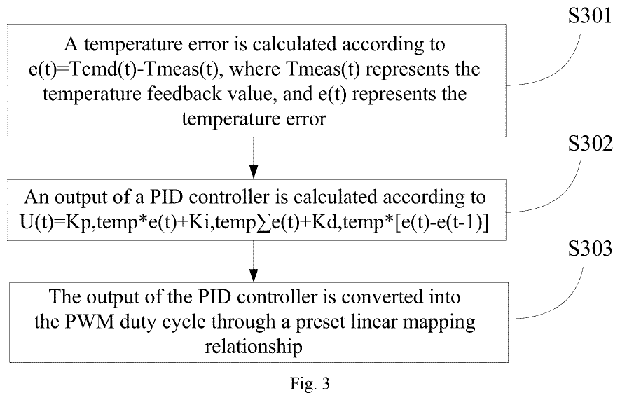

FIG. 3 is a flow chart of the method for intelligently controlling the freeze dryer according to Embodiment 3 of the present disclosure. Compared to other embodiments of the method, this embodiment provides a detailed description for obtaining the PWM signal and adjusting the heating power based on the PWM signal.

In this embodiment, step (S300) includes the following steps.

(S301) The temperature error is calculated according to e(t)=Tcmd(t)−Tmeas(t), where Tmeas(t) represents the temperature feedback value, and e(t) represents the temperature error.

In an embodiment, the temperature error is key data for subsequent temperature adjustment. Accurate calculation of the temperature error is the foundation for the freeze dryer to achieve precise temperature control.

(S302) An output of a PID controller is calculated according to U(t)=Kp,temp*e(t)+Ki,tempΣe(t)+Kd,temp*[e(t)−e(t−1)], where U(t) represents the output of the PID controller, Kp,temp represents a preset temperature proportional gain coefficient, Ki,temp represents a preset temperature integral gain coefficient, Kd,temp represents a preset temperature differential gain coefficient, e(t) represents a temperature error at the current moment, e(t−1) represents a temperature error at a previous sampling moment, and Σe(t) represents a cumulative sum of the temperature error from the initial moment to the current moment.

In an embodiment, the PID controller achieves precise temperature control by comprehensively considering a current temperature error, a cumulative temperature error, and a change rate of the temperature error. Such control strategy enables rapid response to temperature deviations, eliminates continuous deviations under steady-state conditions, and simultaneously suppresses temperature fluctuations and over-adjustment, thereby improving both the stability and the response speed of temperature control.

(S303) The output of the PID controller is converted into the PWM duty cycle through a preset linear mapping relationship.

In an embodiment, the output U(t) of the PID controller is a continuous control variable that typically varies within a certain range. Through the preset linear mapping relationship, the output of the PID controller is converted into a corresponding PWM duty cycle, ensuring that a maximum output of the PID controller corresponds to a 100% duty cycle and a minimum output corresponds to a 0% duty cycle, thereby preventing signal overflow or invalidity. Such linear mapping method has simple structure and is easy to implement, ensuring continuity and consistency between a control signal and an implement signal, so that the power drive circuit can accurately control the output power of the heater to achieve precise temperature adjustment.

The method calculates the PWM duty cycle through the PID algorithm based on the temperature error, and transmits the PWM signal corresponding to the PWM duty cycle to the power drive circuit, so as to achieve precise temperature control. The method can effectively reduce an overall duration of the freeze-drying process and improve production efficiency.

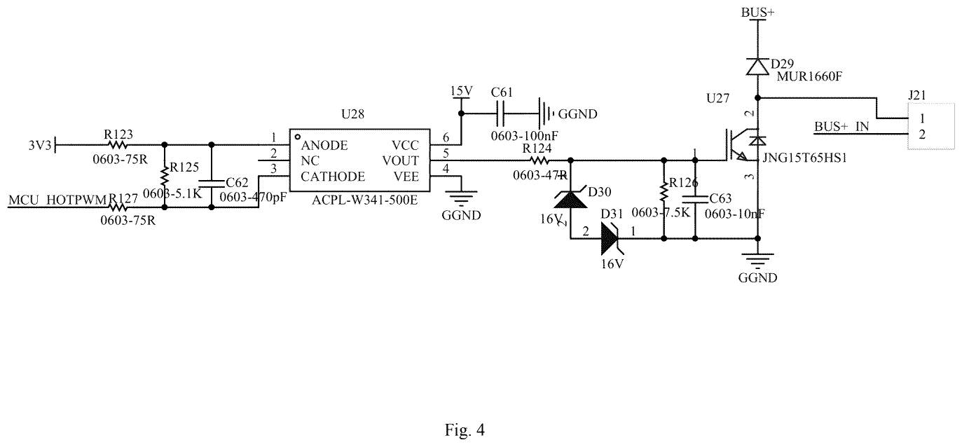

FIG. 4 is schematic diagram of the power drive circuit of the method of the present disclosure.

In an embodiment, the power drive circuit includes a resistor R123, a resistor R127, a resistor R125, a capacitor C62, an optoelectronic isolator U28 of ACPL-W341-500E model, a capacitor C61, a resistor R124, a voltage-regulator diode D30, a voltage-regulator diode D31, a resistor R126, a capacitor C63, a metal-oxide-semiconductor field-effect transistor U27 of YGF2 0N65T2 model and a diode D29. A first pin 1 of the optoelectronic isolator U28 is connected with a first end of the resistor R123, a first end of the resistor R125, and a first end of the capacitor C62. A second pin 3 of the optoelectronic isolator U28 is connected with a first end of the resistor R127, a second end of the resistor R125, and a second end of the capacitor C62. A second end of the resistor R123 is connected with a 3.3V power supply terminal. A second end of the resistor R127 is connected with a PWM signal end. A third pin 4 of the optoelectronic isolator U28 is grounded. A fourth pin 5 of the optoelectronic isolator U28 is connected with a first end of the resistor R124. A fifth pin 6 of the optoelectronic isolator U28 is connected with a 15V power supply terminal and a first end of the capacitor C61. A second end of the capacitor C61 is grounded. A second end of the resistor R124 is connected with a negative electrode of the voltage-regulator diode D30, a first end of the resistor R126, a first end of the capacitor C63 and a grid electrode of the MOSFET U27. A positive electrode of the voltage-regulator diode D30 is connected with a positive electrode of the voltage-regulator diode D31. A negative electrode of the voltage-regulator diode D31 is connected with a second end of the resistor R126, a second end of the capacitor C63, a source electrode of the MOSFET U27 and a ground end. A drain electrode of the MOSFET U27 is connected with a positive electrode of the diode D29 and the heater of the freeze dryer. A negative electrode of the diode D29 is connected with a BUS+ terminal.

In an embodiment, the optoelectronic isolator U28 can safely isolate a rectified 110V direct current (DC) bus from a low-voltage control circuit, preventing damage from high voltage and reducing interference. The MOSFET U27 has characteristics of fast switching speed, low on-resistance and high efficiency, which is t suitable for high-frequency PWM control. In the power drive circuit, the optoelectronic isolator U28 provides safe isolation between the drive signal and a high-voltage power side, while the MOSFET U27 performs PWM chopping control on the rectified direct current bus, thereby achieving efficient and precise power adjustment, which meets the requirements for fine temperature control in the freeze-drying process.

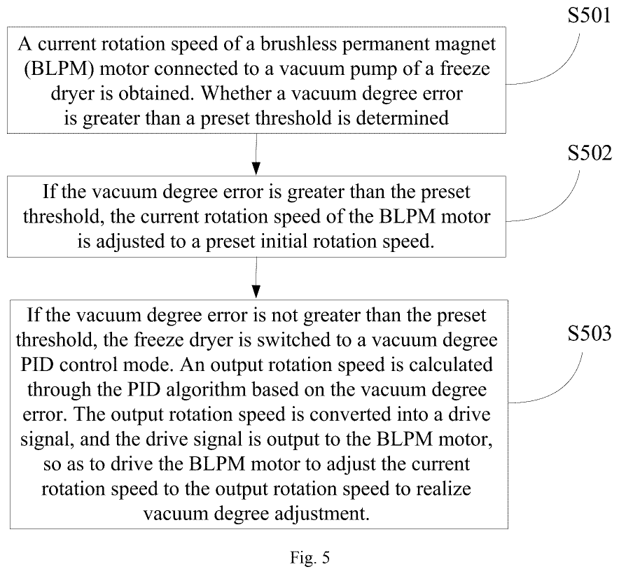

FIG. 5 is a flow chart of the method for intelligently controlling the freeze dryer according to Embodiment 4 of the present disclosure. This embodiment, based on Embodiment 1 of the present disclosure, adds a step of dynamically adjusting the rotation speed of the BLPM motor based on the change of the vacuum degree to achieve precise vacuum degree adjustment.

In this embodiment, the method, after step (S400), further includes the following steps.

(S501) The current rotation speed of the BLPM motor is obtained. Whether the vacuum degree error is greater than a preset threshold is determined.

In an embodiment, the current rotation speed of the BLPM motor is the rotation speed of the BLPM connected to the vacuum pump of the freeze dryer in real-time operation, usually expressed in revolutions per minute (RPM). Speed information of the BLPM motor can be collected in real time through sensors, such as a Hall sensor and an encoder built into the BLPM motor, or a feedback signal from the controller. A minimum rotation speed of the BLPM can be set at 100 rpm, and a maximum rotation speed of the BLPM can be set at 3000 rpm. In this embodiment, the preset threshold is 10 Pa, such value is determined based on the process requirements of the freeze dryer and actual operation experience, which can not only ensure rapid response of the control system, but also avoid unstable operation state caused by frequent switching of the rotation speed of the BLPM motor, thereby achieving efficient and stable control of the vacuum degree.

(S502) If the vacuum degree error is greater than the preset threshold, the current rotation speed of the BLPM motor is adjusted to a preset initial rotation speed.

In an embodiment, if the vacuum degree error is relatively great, it indicates that the vacuum degree feedback value deviates far from the vacuum degree set value. At this time, it is not suitable to directly adopt PID control. The BLPM motor will operate at a fixed preset initial rotation speed, ensuring that the vacuum pump can rapidly reduce the vacuum degree error with stable and high pumping capacity, and avoiding unstable operation of the BLPM motor caused by frequent speed adjustments.

(S503) If the vacuum degree error is not greater than the preset threshold, the freeze dryer is switched to a vacuum degree PID control mode. An output rotation speed is calculated through the PID algorithm based on the vacuum degree error. The output rotation speed is converted into a drive signal, and the drive signal is output to the BLPM motor, so as to drive the BLPM motor to adjust the current rotation speed to the output rotation speed to realize vacuum degree adjustment.

In an embodiment, if the vacuum degree error is relatively small (A is not greater than B refers to A less is than or equal to B), a closed-loop adjustment advantage of PID control can be utilized to achieve precise control and stable maintenance of the vacuum degree. In this embodiment, the PID algorithm is set to perform a calculation at intervals of 0.1 seconds, so as to ensure a timely and smooth response. It should be noted that the drive signal is a PWM signal. By adjusting the duty cycle of the PWM, a drive voltage of the BLPM motor can be changed, thereby achieving the adjustment of the current rotation speed of the BLPM motor.

Step (S502) and step (S503) reflect different speed control strategies for the BLPM motor. There is no specific sequence between such two steps, and either one may be implemented.

The method of the present disclosure utilizes the advantage of the adjustable speed feature of the BLPM motor. The BLPM motor drives a compressor, that is, the vacuum pump to achieve rapid adjustment and high-precision control of the vacuum degree by the compressor.

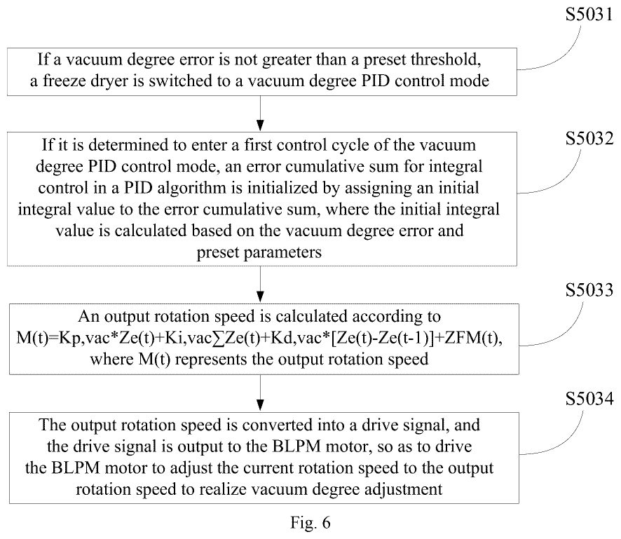

FIG. 6 is a flow chart of the method for intelligently controlling the freeze dryer according to Embodiment 5 of the present disclosure. Compared to other embodiments of the method, this embodiment provides a detailed description for obtaining the output rotation speed, and adjusting the vacuum degree based on the output rotation speed.

In this embodiment, step (S503) includes the following steps.

(S5031) If the vacuum degree error is not greater than the preset threshold, the freeze dryer is switched to the vacuum degree PID control mode.

In an embodiment, the vacuum degree PID control mode is a loop closed-loop feedback control method, which can dynamically adjust the rotation speed of the BLPM motor according to the size, cumulative value and change rate of the vacuum degree error to achieve fine adjustment.

(S5032) If it is determined to enter a first control cycle of the vacuum degree PID control mode, an error cumulative sum for integral control in the PID algorithm is initialized by assigning an initial integral value to the error cumulative sum, where the initial integral value is calculated based on the vacuum degree error and preset parameters.

In an embodiment, when the BLPM motor is switched from a fixed preset initial rotation speed mode to the vacuum degree PID control mode, the rotation speed of the BLPM motor needs to be transited smoothly from the preset initial rotation speed to the output rotation speed calculated by the PID algorithm. At this time, if the cumulative sum of the vacuum degree error from the PID algorithm is directly used, it may cause a sudden change in the integral term, leading to abrupt speed variations or oscillations that could affect the operational stability of the BLPM motor. Therefore, before the vacuum degree PID control mode enters the first control cycle, the cumulative sum of the vacuum degree error needs to be initialized to assign the initial integral value. Such initial integral value is calculated based on a current vacuum degree error and the preset parameters, with an aim of ensuring a smooth transition between the current rotation speed and the output rotation speed. By initializing the integral term, it can be ensured that a first output rotation speed of the vacuum degree PID control mode does not exhibit abrupt changes, thereby avoiding severe rotation speed fluctuations and enhancing the dynamic response performance and stability of the BLPM motor.

(S5033) The output rotation speed is calculated according to M(t)=Kp,vac*Ze(t)+Ki,vacΣZe(t)+Kd,vac*[Ze(t)−Ze(t−1)]+ZFM(t); where M(t) represents the output rotation speed, Kp,vac represents the preset vacuum degree proportional gain coefficient, Ki,vac represents the preset vacuum degree integral gain coefficient, Kd,vac represents a preset vacuum degree differential gain coefficient, Ze(t) represents a vacuum degree error at the current moment, Ze(t−1) represents a vacuum degree error at a previous sampling moment, ΣZe(t) represents the cumulative sum of the vacuum degree error from the initial moment to the current moment, and ZFM(t) represents a preset rotation speed feedforward value of the BLPM motor.

In an embodiment, PID calculation formula fully exploits advantages of proportion, integration and differentiation, achieving comprehensive regulation of the vacuum degree error, thereby ensuring precise control of vacuum degree. An introduced feedforward term, that is, the preset rotation speed feedforward value, is obtained based on experimental tests and can compensate in advance for the load changes of the control system, reduce errors, and thereby improve the response accuracy of the vacuum degree PID control.

(S5034) The output rotation speed is converted into the drive signal, and the drive signal is output to the BLPM motor, so as to drive the BLPM motor to adjust the current rotation speed to the output rotation speed to realize vacuum degree adjustment.

The converted drive signal is output to a driver of the BLPM motor in the form of PWM duty cycle, so that the driver can adjust a current and magnetic field of the BLPM motor according to the drive signal, thereby achieving the change of the rotation speed of the BLPM motor. The BLPM motor can change an operating state of the vacuum pump by adjusting its rotation speed, thereby adjusting the vacuum degree. By continuously calculating the output rotation speed and converting it into the drive signal of the PWM duty cycle, the closed-loop control loop is formed, which can respond to the vacuum degree error in real time dynamically adjust the rotation speed of the BLPM motor, and ensure that the vacuum degree is stabilized within a reasonable range.

In the method of the present disclosure, before the vacuum degree PID control mode enters the first control cycle, the cumulative sum of the vacuum degree error is initialized, so as to ensure smooth switching of the rotation speed of the BLPM motor. Such operation effectively avoids sudden change impact brought by the integration term, achieving a smooth transition from the fixed preset initial rotation speed to the output rotation speed calculated by PID algorithm, and enhancing the stability and control accuracy of vacuum degree adjustment.

Embodiments of a freeze-drying system provided in the present disclosure are described as follows. The embodiments of the freeze-drying system and the embodiments of the method for intelligently controlling the freeze dryer above belong to the same concept. Content of the freeze-drying system that is not described in detail in the embodiments can be referred to the embodiments of the method above.

In this embodiment, a freeze-drying system includes a freeze dryer and a control system. The freeze dryer is electrically connected with the control system. The control system includes a memory 1005 and a processor 1001. The memory 1005 is configured to store a program instruction, and the processor is configured to execute the program instruction to perform the method for intelligently controlling the freeze dryer above.

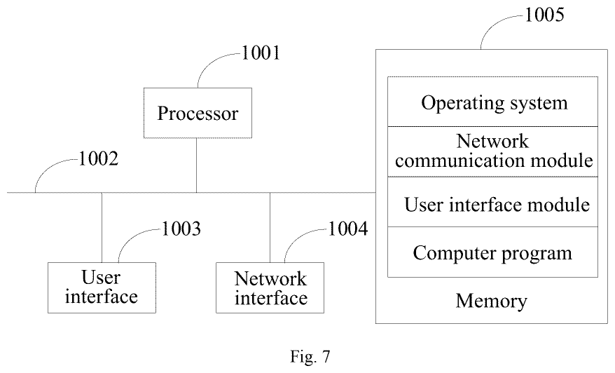

FIG. 7 is a structural diagram of the control system in a hardware operating environment of the present disclosure.

In an embodiment, the control system can be a computing device including a desktop computer, a notebook computer, a handheld computer and a server. Referring to FIG. 7, the control system includes the processor 1001 (such as a central processing unit (CPU)), a network interface 1004, a user interface 1003, the memory 1005, and a communication bus 1002. The communication bus 1002 is configured to enable communication among these components. The user interface 1003 includes a display and an input unit, such as a keyboard. In an embodiment, the user interface 1003 further includes a standard wired interface or a wireless interface. In an embodiment, the network interface 1004 includes a standard wired interface or a wireless interface, such as a wireless fidelity (Wi-Fi) interface. The memory 1005 can be a high-speed RAM memory or a non-volatile memory, such as a magnetic disk memory. The memory 1005 can also be a storage device independent of the processor 1001.

It can be understood by those skilled in the art that the structure of the control system shown in FIG. 7 does not limit the control system. The control system of the present disclosure can include more or fewer components than shown in FIG. 7, or combine certain components, or have different component arrangement.

Referring to FIG. 7, the memory 1005, as a computer storage medium, can include an operating system, a network communication module, a user interface module, and a computer program.

In the control system shown in FIG. 7, the network interface 1004 is primarily configured to connect to a backend server and perform data communication with the backend server. The user interface 1003 is primarily configured to connect to a user end, and perform data communication with the user end. The processor 1001 can be configured to invoke the computer program stored in the memory 1005. When the computer program is invoked and executed by the processor 1001, the steps of the method above are implemented.

The freeze-drying system of the present disclosure, being capable of realizing the steps of the method for intelligently controlling the freeze dryer, has at least all beneficial effects brought by the technical solutions of the embodiments of the method above, which will not be elaborated herein.

Described above are only some or preferred embodiments of the present disclosure, which are not intended to limit the disclosure. Under the sprits of this application, any equivalent replacements or direct/indirect application in other arts by utilizing the specification and accompanying drawings of this application shall fall within the scope of this application defined by the appended claims.

It should be understood by those skilled in the art that the embodiments of the present disclosure can be implemented as a method, a system, or a program product. Therefore, the present disclosure can be implemented in the following forms: complete hardware, complete software or a combination of hardware and software. In addition, the embodied in the form of a computer program product implemented on one or more computer-usable storage media (including, but not limited to, magnetic disk storage, CD-ROM, optical storage, etc.) containing computer-usable program code.

This application is described with reference to flowcharts and/or block diagrams of methods, devices (systems), and computer program products according to embodiments of the present disclosure. It should be understood that each process and/or block in the flowcharts and/or block diagrams, and a combination thereof can be implemented by computer program instructions. These computer program instructions can be provided to a general-purpose computer, a dedicated computer, an embedded processor, or other programmable data processing devices to configure a machine. This machine, when operated by the computer or other programmable data processing devices, produces an apparatus that performs the functions specified in one or more processes of the flowchart and/or one or more blocks of the block diagram.

These computer program instructions can also be stored in a computer-readable storage medium that can be used to configure a computer or other programmable data processing device to operate in a specific manner. The instructions stored in the computer-readable storage medium produce an article of manufacture that includes the instructions, and implements the functions specified in one or more processes of the flowchart and/or one or more blocks of the block diagram.

The computer program instructions can also be loaded onto a computer or other programmable data processing devices, causing the computer or other programmable devices to execute a series of operational steps to produce a machine-implemented process. As a result, the instructions executed by the computer or other programmable devices provide steps for performing the functions specified in one or more processes of the flowchart and/or one or more blocks of the block diagram.

Described above are only for illustrating the technical ideas of the present disclosure, which is not intended to limit the scope of this application. It should be understood by those skilled in the art that any modifications and equivalent replacements made without departing the spirit of the present disclosure shall fall within the scope of this application defined by the appended claims.

What is claimed is:

1. A method for intelligently controlling a freeze dryer, comprising:
obtaining initialization parameters of the freeze dryer, and collecting a temperature feedback value and a vacuum degree feedback value of the freeze dryer; wherein the initialization parameters comprise a temperature set value and a vacuum degree set value;
determining whether the vacuum degree feedback value meets a preset condition; if yes, calculating a temperature command value through a proportional-integral (PI) algorithm according to the vacuum degree feedback value and the vacuum degree set value, otherwise, setting the temperature command value to the temperature set value;
calculating a temperature error according to the temperature command value and the temperature feedback value; and calculating a pulse-width modulation (PWM) duty cycle through a proportional-integral-derivative (PID) algorithm based on the temperature error; and
generating a PWM signal based on the PWM duty cycle, and transmitting the PWM signal to a power drive circuit of the freeze dryer, such that the power drive circuit adjusts an actual power output of a heater of the freeze dryer according to the PWM signal to achieve temperature control.

2. The method of claim 1, wherein the preset condition is that a current rotation speed of a brushless permanent magnet (BLPM) motor connected with a vacuum pump of the freeze dryer reaches a maximum rotation speed, and the vacuum degree feedback value continues to increase.

3. The method of claim 1, wherein step of calculating the temperature command value through the PI algorithm according to the vacuum degree feedback value and the vacuum degree set value comprises:
calculating a vacuum degree error according to Ze(t)=Zset−Zmeas(t), wherein Zmeas(t) represents the vacuum degree feedback value, Zset represents the vacuum degree set value, and Ze(t) represents the vacuum degree error; and
calculating the temperature command value according to Tcmd(t)=Tset−[Kp,vac*Ze(t)+Ki,vacΣZe(t)], wherein Tcmd(t) represents the temperature command value, Tset represents the temperature set value, Kp,vac represents a preset vacuum degree proportional gain coefficient, Ki,vac represents a preset vacuum degree integral gain coefficient, and ΣZe(t) represents a cumulative sum of the vacuum degree error from an initial moment to a current moment; and
step of setting the temperature command value to the temperature set value comprises:
designating the temperature command value as Tcmd(t) and the temperature set value as Tset, wherein Tcmd(t)=Tset.

4. The method of claim 3, wherein step of calculating the temperature error according to the temperature command value and the temperature feedback value comprises:
calculating the temperature error according to e(t)=Tcmd(t)−Tmeas(t), wherein Tmeas(t) represents the temperature feedback value, and e(t) represents the temperature error.

5. The method of claim 4, wherein step of calculating the PWM duty cycle through the PID algorithm based on the temperature error comprises:
calculating an output of a PID controller according to U(t)=Kp,temp*e(t)+Ki,tempΣe(t)+Kd,temp*[e(t)−e(t−1)], wherein U(t) represents the output of the PID controller, Kp,temp represents a preset temperature proportional gain coefficient, Ki,temp represents a preset temperature integral gain coefficient, Kd,temp represents a preset temperature differential gain coefficient, e(t) represents a temperature error at the current moment, e(t−1) represents a temperature error at a previous sampling moment, and Σe(t) represents a cumulative sum of the temperature error from the initial moment to the current moment; and
converting the output of the PID controller into the PWM duty cycle through a preset linear mapping relationship.

6. The method of claim 3, wherein the method, after step of transmitting the PWM signal to the power drive circuit of the freeze dryer, further comprises:
obtaining the current rotation speed of the BLPM motor; and determining whether the vacuum degree error is greater than a preset threshold;
if the vacuum degree error is greater than the preset threshold, adjusting the current rotation speed of the BLPM motor to a preset initial rotation speed; and
if the vacuum degree error is not greater than the preset threshold, switching the freeze dryer to a vacuum degree PID control mode; calculating an output rotation speed through the PID algorithm based on the vacuum degree error; converting the output rotation speed into a drive signal, and outputting the drive signal to the BLPM motor, so as to drive the BLPM motor to adjust the current rotation speed to the output rotation speed to realize vacuum degree adjustment.

7. The method of claim 6, wherein step of calculating the output rotation speed through the PID algorithm based on the vacuum degree error comprises:
calculating the output rotation speed according to M(t)=Kp,vac*Ze(t)+Ki,vacΣZe(t)+Kd,vac*[Ze(t)−Ze(t−1)]+ZFM(t); wherein M(t) represents the output rotation speed, Kp,vac represents the preset vacuum degree proportional gain coefficient, Ki,vac represents the preset vacuum degree integral gain coefficient, Kd,vac represents a preset vacuum degree differential gain coefficient, Ze(t) represents a vacuum degree error at the current moment, Ze(t−1) represents a vacuum degree error at a previous sampling moment, ΣZe(t) represents the cumulative sum of the vacuum degree error from the initial moment to the current moment, and ZFM(t) represents a preset rotation speed feedforward value of the BLPM motor.

8. The method of claim 6, wherein after step of switching the freeze dryer to the vacuum degree PID control mode, and prior to step of calculating the output rotation speed through the PID algorithm based on the vacuum degree error, the method further comprises:
if it is determined to enter a first control cycle of the vacuum degree PID control mode, and initializing an error cumulative sum for integral control in the PID algorithm by assigning an initial integral value to the error cumulative sum, wherein the initial integral value is calculated based on the vacuum degree error and preset parameters.

9. The method of claim 1, wherein the power drive circuit comprises a first resistor, a second resistor, a third resistor, a first capacitor, an optoelectronic isolator, a second capacitor, a fourth resistor, a first voltage-regulator diode, a second voltage-regulator diode, a fifth resistor, a third capacitor, a metal-oxide-semiconductor field-effect transistor (MOSFET) and a diode; and
a first pin of the optoelectronic isolator is connected with a first end of the first resistor, a first end of the third resistor and a first end of the first capacitor; a second pin of the optoelectronic isolator is connected with a first end of the second resistor, a second end of the third resistor and a second end of the first capacitor; a second end of the first resistor is connected with a 3.3V power supply terminal; a second end of the second resistor is connected with a PWM signal end; a third pin of the optoelectronic isolator is grounded; a fourth pin of the optoelectronic isolator is connected with a first end of the fourth resistor; a fifth pin of the optoelectronic isolator is connected with a 15V power supply terminal and a first end of the second capacitor; a second end of the second capacitor is grounded; a second end of the fourth resistor is connected with a negative electrode of the first voltage-regulator diode, a first end of the fifth resistor, a first end of the third capacitor and a grid electrode of the MOSFET; a positive electrode of the first voltage-regulator diode is connected with a positive electrode of the second voltage-regulator diode; a negative electrode of the second voltage-regulator diode is connected with a second end of the fifth resistor, a second end of the third capacitor, a source electrode of the MOSFET and a ground end; a drain electrode of the MOSFET is connected with a positive electrode of the diode and the heater of the freeze dryer; and a negative electrode of the diode is connected with a BUS+ terminal.

10. A freeze-drying system, comprising:
a freeze dryer; and
a control system;
wherein the freeze dryer is electrically connected with the control system;
the control system comprises a memory and a processor; and
the memory is configured to store a program instruction; and the processor is configured to execute the program instruction to perform the method of claim 1.
